(19) United States
(12) Patent Application Publication
(10) Pub. No.: US 2003/0164071 A1
(43) Pub. Date: Sep. 4, 2003

(54) Spinner device

(76) Inventors: Magne Moe, Harstad (NO); Per Olav Haughom, Tonstad (NO); Jorn Pollestad, Bryne (NO)

Correspondence Address: Andrus Sceales Starke & Sawall, 100 East Wisconsin Avenue, Suite 1100, Milwaukee, WI, 53202, US

(21) Appl. No.: 10/258,678

(22) PCT Filed: Apr. 25, 2001
(86) PCT No.: PCT/NO01/00171

(30) Foreign Application Priority Data
Apr. 28, 2000 (NO) 20002258

(51) Int. Cl. B25B 17/00

(52) U.S. Cl. 81/57.2

(57) ABSTRACT

In spinner tongs, a so-called spinner (30), incorporated in an iron roughneck and thus serving to rotate a drill pipe during connection thereof to a drill string or during division of the drill string into individual pipes, the aim has been to reduce damage on the threaded connections (the pin-and-box joints) in the screwing/unscrewing operations. This is realized in an operation for the simultaneous centring and rotating of the drill pipe. Four spinner rollers (42) known in themselves, which are brought to bear on the drill pipe when surrounding it, are mounted according to the invention, preferably in pairs, at the outer ends of driven clamping arms (46), by bogies (50). At their opposite outer ends the clamping arms (46) are pivotally supported on a fixed frame part/structure (56) and are jointed to each other by means of a piston and cylinder (48) driven by pressure fluid and arranged to carry the clamping arms (46) towards and away from each other. For their forced centring the clamping arms (46) have a centring stay (58) arranged thereto, which is connected by its outer end to one clamping arm (46), and is connected by its other outer end to the other clamping arm (46). For the parallel displacement of the rollers (42), each bogie (50) has a parallel stay (54) arranged thereto, whose other end is supported on a fixed frame part/structure (56).

This invention relates to a spinner/spinner tong device for use in the screwing or unscrewing of threaded connections in the form of internally threaded box ends, each to be brought into engagement with/disengaged from an externally threaded pin end of an adjacent pipe length or pipe section, especially lengths of drill pipe of the kind being screwed together for the formation of a continuous drill string for use in connection with the drilling for oil and gas deposits.

In the following a spinner indicates a spinner or spinner tongs, unless otherwise explicitly specified.

When a drill string is to be pulled out of the well bore or assembled immediately above it, for example in connection with replacement of drill bit, the entire drill string length is used must be hoisted or lowered by mans of draw works in the derrick of the rig.

Screwing of the threaded connections (boxes and pipe end pins) ensures the connection of lengths of drill pipe or division of the drill string, according to what is required in the individual case. Screwing is effected by means of an s iron roughneck, which comprises partly a fast-rotating screwing device/unscrewing device of a small torque, in the form of a spinner, and a device which may effect tightening/unscrewing at a desired maximum torque on the pipe box, in the form of a so-called torque wrench.

In principle, a spinner is formed with four rollers, each driven by a separate hydraulic motor. The rollers are forced against the drill pipe wall by means of hydraulic piston and cylinders.

There are several known embodiments, in which devices are arranged to force rollers against the drill pipe.

From Norwegian patent document No. 306 573 is known a torque wrench for the torqued tightening of drill pipes with boxes, in which the upper and lower clamping jaws are operated by hydraulic cylinders, and there is a spinner arranged to a main structure. A torque wrench is mounted by a quick-release coupling to a telescopic manipulator arm, which can be pivoted about a vertical axis by means of a slewing ring, which is fixedly connected to a drill floor of a sea-based installation.

In connection with the torque wrench according to NO 306 573, the aim has been to arrange the torque wrench so, that it has been assigned and covers a wide working area. Clamping jaws are arranged, which are rotated by means of a gear rim connected to a gear. The latter is brought into rotation by a planetary gear, thereby securing, through the rotation of the clamping jaws, the rotary motion necessary for the screwing (unscrewing). A spinner is here equipped with a mechanical synchronizing gear drive between the drive rollers.

Of other known devices for the screwing of pipe joining devices on drill pipe ends, may be mentioned for example GB 1 416 245, GB 1 469 661, GB 1 519 086 and NO 143 235.

An unfavourable common feature of known embodiments is, however, that they are not formed to allow centring of the drill pipe, which is to be lowered into the opposite box as two drill pipes are being screwed together.

When the drill pipes are to be unscrewed from one another, it is important that the weight of the drill pipe is released when the last thread leaves the box, so that there will be no impact against the threaded connection.

This approach to the problems forms the basis of the present invention, whose general object it has been, by simple and reasonable means, to provide a spinner which both rotates and centres the length of drill pipe concerned, which is to be screwed together with the opposite threaded box. The spinner should also be arranged to relieve the threads with respect to weight load when the last thread leaves the box in the parting of pin-and-box joints.

For the purpose mentioned the invention is characterized by the features specified in the characterizing part of the independent claim 1. Advantageous, but subordinate features, which are not critical to the intended function and technical effect of the invention, appear from the subsequent dependent subordinate claims.

A spinner of this kind comprises a frame part/structure with steering/guide rollers mounted on two vertical guides and comprising preferably four driven rotary rollers for the rotation of a drill pipe, said rotary rollers being manufactured from steel or a similar hard metal or metal alloy, and being driven by means of preferably hydraulic motors. According to the invention the driven rotary rollers are supported on bogies mounted on clamping arms, which are manoeuvred by means of a manoeuvring device in the form of a transverse hydraulic piston and cylinder or other actuator, parallel displacement stays and centring stays being arranged for said clamping arms.

For the spinner tongs a further piston and cylinder may be arranged, which exhibits sufficient lifting power to raise the spinner and drill pipe. Thereby the spinner and pipe section can be lifted free of the threaded potion when the pipes are being unscrewed from one another.

Said parallel displacement stays and centring stays may be provided with a spring-based centring unit, for example comprising two individual springs.

The device according to the invention is also formed with a view to reducing damage on the threaded connections as drill pipe sections are being screwed and unscrewed. Damage of the kind reduced or even eliminated through the present invention, has at all times represented an increased risk of drill string breakdown, with great economic consequences.

Non-limiting examples of preferred embodiments of devices formed and arranged in accordance with the present invention are explained in further detail in the following, with reference to the accompanying drawings, in which:

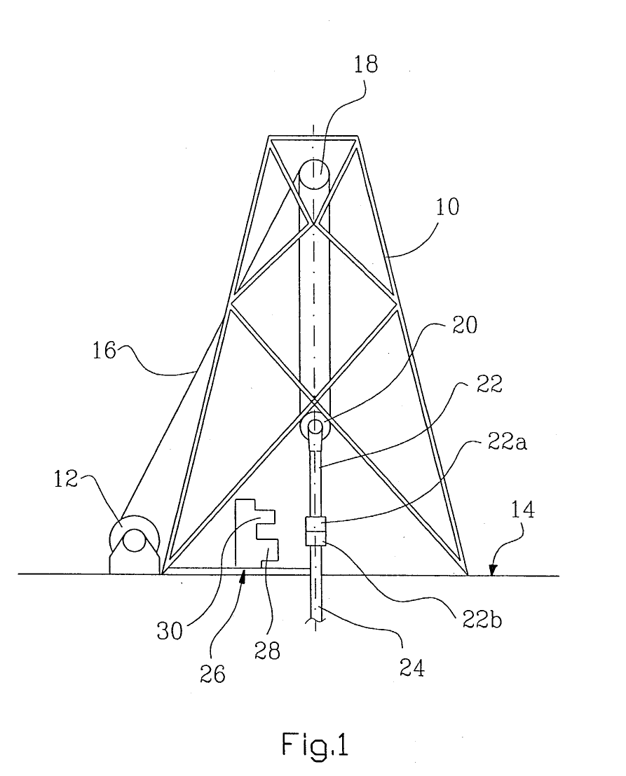

FIG. 1 shows in a side view a principle drawing illustrating a highly simplified derrick with draw works, an iron roughneck and a suspension device for suspending lengths of drill pipe which are to be screwed together and made up by the threaded connections by means of the iron roughneck for the formation of a continuous drill string;

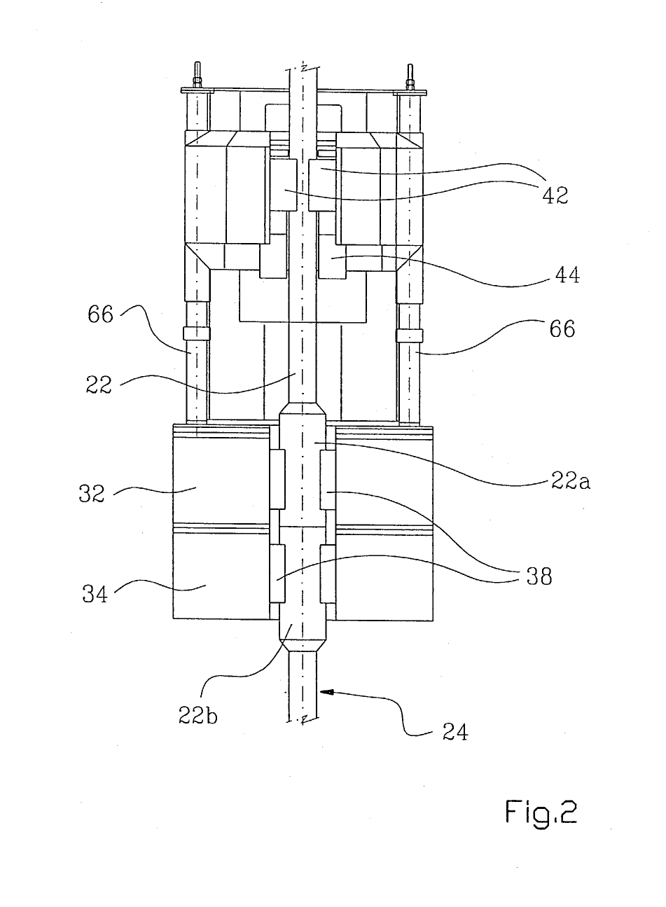

FIG. 2 shows a front view of the iron roughneck;

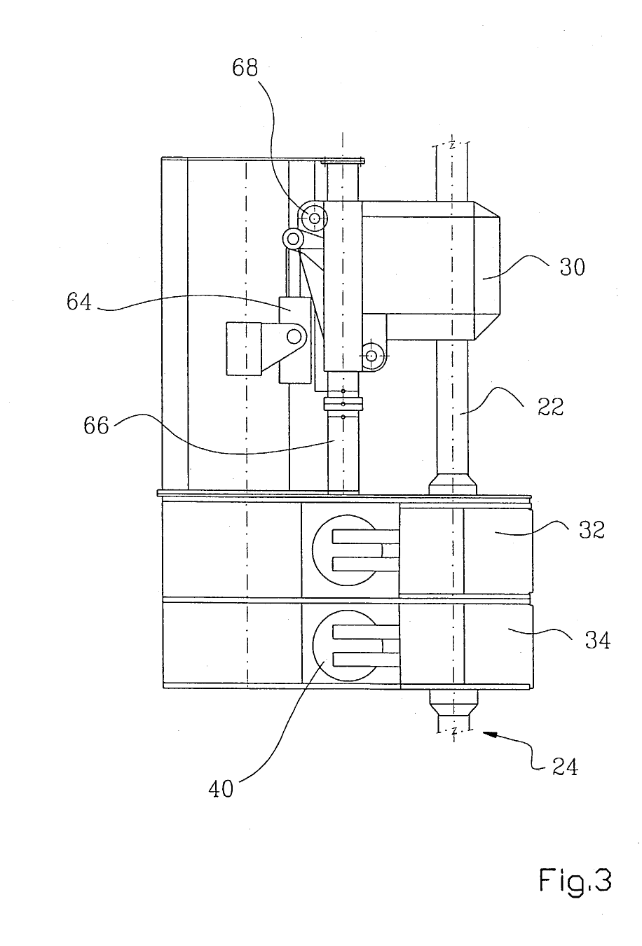

FIG. 3 shows the iron roughneck shown in FIG. 2 in a side view;

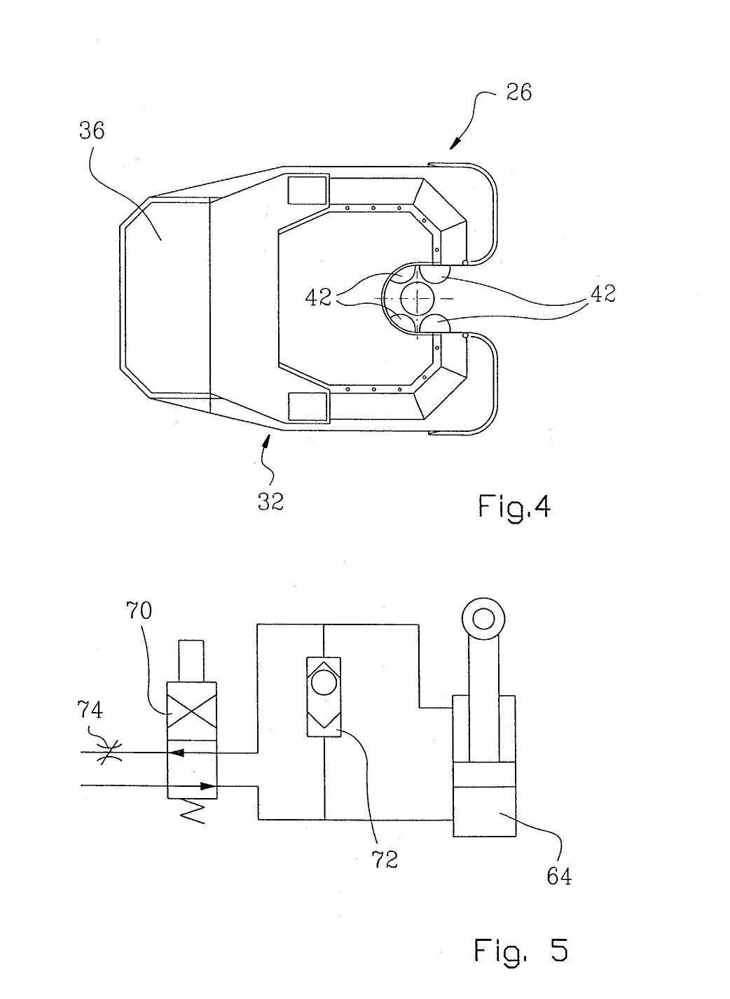

FIG. 4 shows the iron roughneck in a top plan view;

FIG. 5 shows a circuit diagram of a pressure air circuit for the lifting cylinder of the spinner;

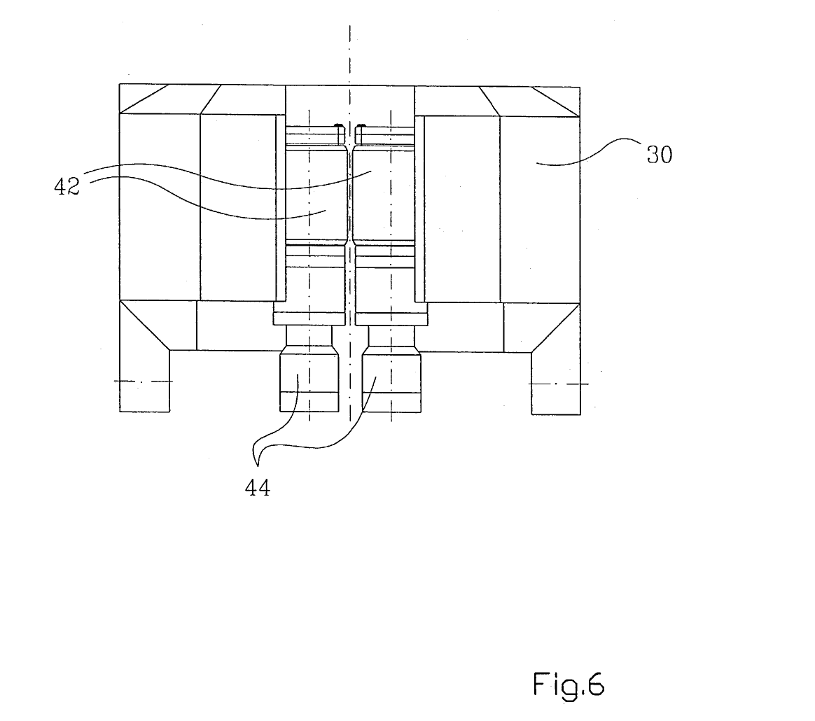

FIG. 6 shows the spinner itself in elevation;

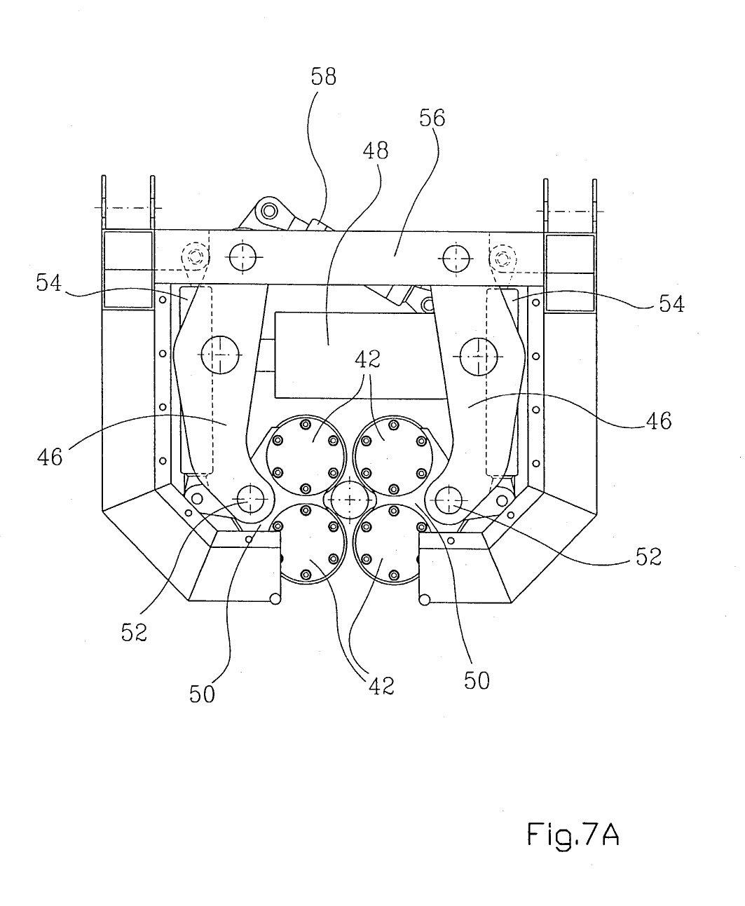

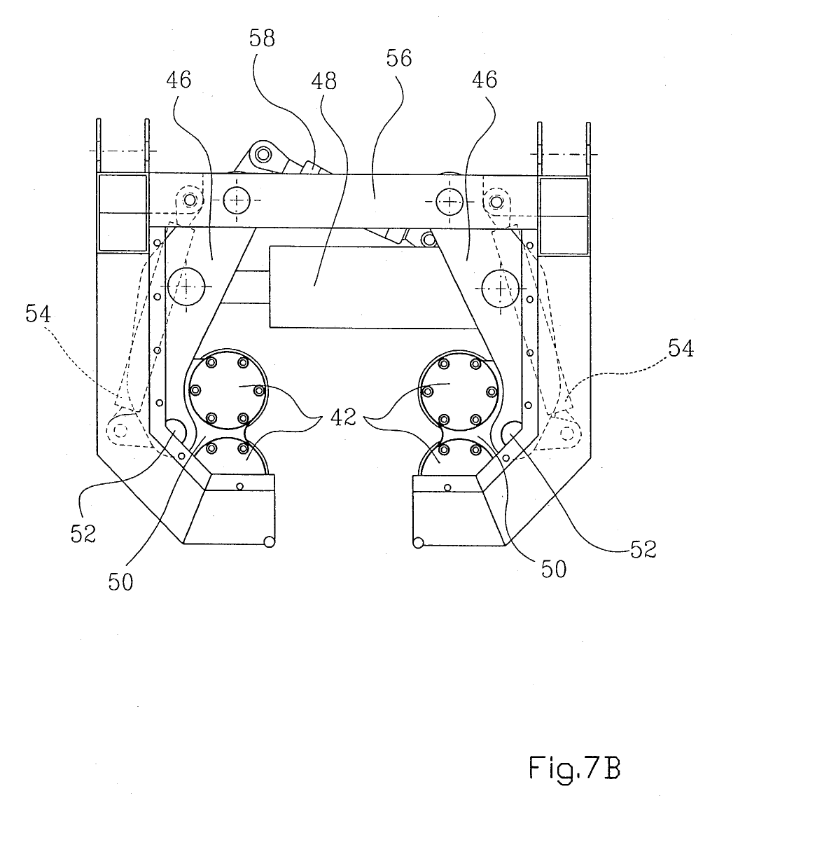

FIG. 7A is a top plan view of the spinner shown in a more detailed configuration, and with the drive rollers pivoted inwards towards one another, so that they adopt inner active positions for the rotation of a drill pipe not shown;

FIG. 7B corresponds to FIG. 7A, except that here the drive rollers have been carried away from each other and are spaced apart in the transverse direction, thereby adopting their idle stand-by positions;

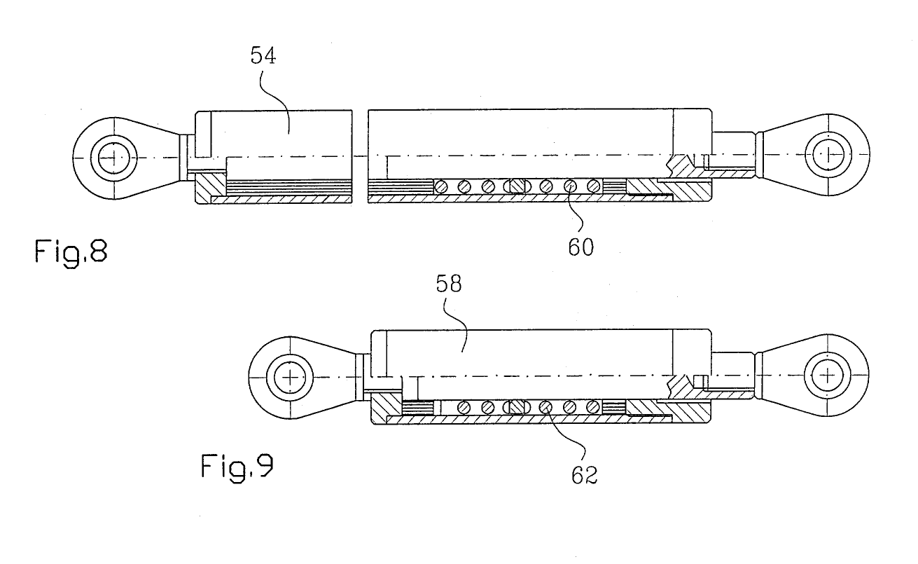

FIG. 8 shows separately a parallel stay for the parallel displacement of the drive/rotary rollers;

FIG. 9 shows separately a synchronizing stay, for not shown clamping arms carrying the driven, pivotable drive/rotary rollers by bogies.

Reference is made to FIG. 1, in which the reference numeral 10 identifies a derrick with draw works 12 arranged thereto on the drill floor 14 of a platform, not shown in further detail, a wire line 16 leading from the draw works 12 up to a tackle 18 suspended from the derrick 10, and carrying through the wire line 16 an underlying tackle 20, from which the drill pipe length/section 22 is suspended.

A number of such lengths/sections 22 of drill pipe are to be joined together through pin-and-box connections consisting of an upper part 22a and a lower part 22b in the form of a threaded male part, “a pin”, and a threaded female part, “a box”, for the formation of a continuous drill string 24.

For screwing together the drill pipe lengths/sections 22 and tightening the threaded connections at the ends thereof, an iron roughneck is used, generally identified by the reference numeral 26, in principle comprising two main components, a lower component in the form of a torque wrench 28, and an upper component in the form of a spinner 30. The drill string 24 is lifted and lowered into the borehole (not shown) by means of the draw works 12, whose wire line 16 runs over the tackles 18, 20 suspended from the derrick 10. This represents well-known technique.

The torque wrench 28 itself comprises two parts, namely an upper part 32 and a lower part 34, FIGS. 2 and 3. The lower part 34 of the torque wrench 28 is fixedly connected to a frame part or structure 36, whereas the upper torque wrench part 32 can be pivoted through a given angle relative to the lower torque wrench part 34, the torque wrench 28 being provided with clamping jaws 38, which are brought to grip and clamp a drill pipe 22 by means of hydraulic piston and cylinders 40.

When drill pipe lengths/sections 22 are to be screwed together for the formation of a continuous drill string 24, the lower part 34 of the torque wrench 28 will first be is brought to grip about the lower portion of the box connection part 22b. Then the pipe section/length 22 is placed in the spinner 30 by means of a not shown pipe handling device of a known embodiment.

According to the invention the spinner 30 is formed and arranged to centre the respective pipe 22, and on reception of the pipe it provides for it to be centred while it is being lowered at the same time with its connecting part, the externally threaded pin/spigot end 22a, into the underlying box part 22b of the joint/threaded connection.

The driven rollers 42 of the spinner 30, which are to rotate the pipe 22, the so-called spinner rollers, are arranged in a number of four, arranged in pairs, two on either side of the pipe 22, referring to the transverse direction of the iron roughneck, FIGS. 4 and 6, are driven by a hydraulic torque motor 44 each, and effect a rotation of the pipe 22 until the upper and lower parts 22a, 22b of the pin-and-box are fully joined.

Then the upper part 32 of the torque wrench part 28 is brought to clamp during rotation, until the desired tightening torque is achieved.

The above-mentioned centring of the pipe 22 within the spinner 30 is effected by means of two clamping arms 46, FIGS. 7A and 7B, which have a piston and cylinder 48 arranged thereto, whereby the clamping arms 46 can be forced together and carried away from each other, each forming a support for a bogie 50 carrying respective two spinner rollers 42. Each bogie 50 is mounted to the outer end of the adjacent clamping arm 46 by a bolt connection 52.

The parallel displacement of the spinner rollers 42 is implemented by means of parallel stays 54, FIGS. 7A and 7B and FIG. 8, secured to a frame part or structure 56 and to respective bogies 50. The centring is provided by a centring stay (synchronizing stay) 58, FIGS. 7A and 7B and FIG. 9, jointed by its axial ends to the clamping arms 46, so that the latter are forcibly centred when the piston and cylinder 48 is being shortened and is pulling the clamping arms 46 together. Such a course of action is represented by FIG. 7A, based on FIG. 7B, in which the clamping arm manoeuvring cylinder 48 is shown in an extended state, with clamping arms 46 and spinner rollers 46 in idle positions, at a maximum, or approximately maximum, distance from each other.

Both the parallel stay 54 and centring stay 58 are provided with an internal shock absorbing spring 60 and 62, respectively, see FIGS. 7A, 7B and FIG. 8 and FIG. 9, respectively.

A pneumatic piston and cylinder 64, FIG. 3, provides for return of the spinner 30 into its initial position when the threaded connection of the pipe joint is made up completely, and the spinner rollers 42 release the grip on the pipe 22. The entire spinner unit 30 is moved vertically along guide rails 66 by means of guide rollers 68, FIG. 3.

When the drill string is to be divided by unscrewing of the threaded connections/pin-and-box connections, the torque wrench 28 first provides the loosening of the pin-and-box joints, so that the spinner 30 may then take over and unscrew the threads that are in engagement. This is implemented in that the spinner 30 is brought to grip about the drill pipe with its rollers 42 bearing on the outer surface thereof, while at the same time the pneumatic piston-and-cylinder 64, FIG. 3, is sized and activated for a power sufficient to lift both the spinner 30 and the drill pipe 22 up freely as the threaded end portion 22a runs out of the underlying box joint 22b.

The pressure air cylinder 64 is activated by means of a valve 70 and a change valve 72. In one valve position the cylinder chambers on both sides of the piston are pressurized. In this position the lifting power of the pressure air cylinder 64 is only sufficient to lift the spinner 30 back into its upper position, FIG. 5. In another valve position the cylinder chamber is pressurized one-sidedly on the piston side, so that the lifting power will be sufficiently great to lift both the spinner 30 and the drill pipe section 22 free of the box connection 22b by the unscrewing. From FIG. 5 it further appears that a choking nozzle 74 is arranged to limit the piston speed to a desired level.

1. A spinning tong/spinner device of the kind incorporated in an iron roughneck, for use in screwing/unscrewing operations in connections with pin-and-box joints/threaded connections (22a,22b) of drill pipes (22) for the formation of a continuous drill string (24), and for the division thereof into individual pipes/sections/lengths (22) after use, respectively, comprising preferably four rotatable, driven spinner rollers (42) arranged to a aligning/guiding device (68, 66) for the vertical direction and formed to impart a rotary motion to the drill pipe (22), characterized in that the spinner rollers (42) are mounted, preferably in pairs, through bogies (50) or similar intermediate elements to driven clamping arms (46) movable towards and away from each other, there being mounted between said clamping arms (46) and jointed thereto, an actuator, for example a piston and cylinder (48) driven by pressure fluid, which effects the forced motion of the clamping arms (46), the clamping arms (46) having, for forced centring, a common centring stay (58), whereas a parallel stay (54) is arranged to each of the bogies (50) for the parallel displacement of the rollers (42).

2. A device according to claim 1, characterized in that said actuator (48) attacks by its axial ends an intermediate portion of each clamping arm (46), said intermediate portion being located between the supporting end and the bogie-carrying end of the respective clamping arm (46).

3. A device according to claim 1 or 2, characterized in that the clamping arms (46) are of identical circumferential shape (in the horizontal plane) from one axial end, which is pivotally supported on a fixed frame part/structure (56), on which also the outer end of each parallel stay (54) is pivotally mounted with a vertical axis, to the second outer end, which is jointed to and carrying the associated bogie (50).

4. A device according to claim 3, characterized in that one outer end of the centring stay (58) is jointed to one clamping arm (46) at a point located on the opposite side of the support point of this clamping arm (46) on said fixed frame part/structure (56) relative to the point of attack of said actuator (48) on this clamping arm (46), and is formed of a support lug which forms the extension/continuation of this clamping arm, whereas the other outer end of the centring stay (58) is jointed to the other clamping arm (46) at a point located on the same side of the supporting point of this clamping arm (46) on the fixed frame part/structure (56) as the point of attack of the actuator (48), and is formed of a support lug projecting sideways from this clamping arm (46) and being positioned between the supporting point thereof and the point of attack of the actuator (48).

5. A device according to any one of the preceding claims, characterized i n that the spinner unit (30) is arranged to be moved vertically along guides or guide rails (66).

6. A device according to claim 5, characterized in that the spinner tongs/spinner (30) have/has a lifting device arranged thereto, for example in the form of a pressure fluid driven, e.g. pneumatic, piston and cylinder (64), which exhibits a lifting power for lifting the spinner (30) and drill pipe (22) at the same time.

7. A device according to claim 6, characterized in that the lifting device in the form of a pneumatic piston and cylinder (64) has an activating valve (70) and a change valve (72) arranged thereto, the pressure air supply/valve arrangement being such that in a first position both cylinder chambers may be pressurized, and in a second position only the chamber on the piston side, the first position corresponding to a lifting power which is only sufficient to lift the spinner (30) alone back into its upper position, whereas the second position corresponds to a lifting power which is sufficient to lift both the spinner and drill pipe (22) free from the box joint (22b) in the unscrewing.

8. A device according to claim 7, characterized in that in the pressure air circuit and valve arrangement of the pneumatic piston and cylinder (64) is incorporated a choking nozzle (74) arranged to limit the piston speed of the cylinder to the desired level.

9. A device according to claim 1, characterized in that both the parallel and centring stays (54 and 58) are provided with a built-in centring spring device each, consisting of two springs (60 and 62, respectively).
